(19) United States
(12) Patent Application Publication
(10) Pub. No.: US 2008/0186610 A1
(43) Pub. Date: Aug. 7, 2008

(54) APPARATUS, SYSTEM, AND METHOD FOR AN "M" SERVO PATTERN

(76) Inventors: Nhan Xuan Bui, Tucson, AZ (US); Robert Allen Hutchins, Tucson, AZ (US); Mark Allan Taylor, Tucson, AZ (US)

Correspondence Address: Kunzler & McKenzie, 8 EAST BROADWAY, SUITE 600, SALT LAKE CITY, UT, 84111, US

(21) Appl. No.: 11/670,913

(22) Filed: Feb. 2, 2007

(51) Int. Cl. G11B 5/02

(52) U.S. Cl. 360/55

(57) ABSTRACT

An apparatus, system, and method are disclosed for an “M” servo pattern. A servo pattern write module is included to simultaneously create a first servo mark, a second servo mark, a third servo mark, and a fourth servo mark in an “M” servo pattern on a magnetic tape. The magnetic tape is configured to store data. The first, second, third, and fourth servo marks are substantially linear and are substantially the same length. The first and third servo marks are positioned with a forward slope comprising first and third legs of the “M” pattern. The second and fourth servo marks are positioned with a backward slope comprising second and fourth legs of the “M” pattern. Distances between center points of the first and second servo marks, second and third servo marks, and third and fourth servo marks are substantially the same.

### BACKGROUND OF THE INVENTION

1. Field of the Invention

This invention relates to magnetic tape servo tracks and more particularly relates to an “M” pattern servo mark.

2. Description of the Related Art

Magnetic tapes are typically moved from one reel, across read and write heads and then onto a take-up reel. As a magnetic tape travels across read and write heads, mechanical servos move the tape laterally, in a direction perpendicular to the travel of the tape, to align read and write heads with data tracks on the tape. To detect the position of the tape with respect to the read and write heads, servo tracks are laid down on the tape prior to writing data to the tape.

FIG. 1 depicts a representative segment of magnetic tape 102 with servo tracks 104 and data tracks 106 along with a direction of travel 108 of the magnetic tape 102. Note that the depicted servo tracks 104 and data tracks 106 are not to scale. A magnetic tape 102 may include several servo tracks 104 with numerous data tracks 106. A typical magnetic 102 tape may include five servo tracks 104. A servo pattern writer typically simultaneously creates all servo tracks 104 on a magnetic tape 102. Servo tracks 104 are read by servo read heads. A pair of servo read heads may be precisely positioned over two of five servo tracks 104 and may include sixteen read heads or sixteen write head between the servo read heads. As the magnetic tape 102 moves across the servo read heads, the servo read heads sense the position of the servo read heads relative to servo marks on the servo tracks 104. The positioning information gathered by the servo read heads is used to position the servo read heads at a particular position on the servo tracks 104. As the servo read heads move, the attached read or write heads also move.

FIG. 2 depicts typical “A” pattern servo marks on a servo track 104 from the prior art. Each “A” pattern servo mark is created by an “A” pattern servo write head that makes two marks at a time. A servo write head may write servo marks that may be read by a magnetic servo read head, an optical servo read head, or other type of servo read head. FIG. 2 depicts two “A” pattern servo marks made by a single “A” pattern servo write head. Typically, an “A” pattern servo mark includes a first servo mark 202, 206 angled in one direction and a second servo mark 204, 208 angled in the opposite direction with respect to a vertical axis 210 perpendicular to the direction of tape travel 108. Typically, the absolute value of the slope of the first and second servo marks 202, 204 is the same in relation to the vertical axis 210. However, servo pattern marks 202, 204 may be angled differently with respect to a vertical axis 210. For example, one servo pattern mark 202 may be aligned vertically and a second servo pattern mark 204 may be sloped with respect to the vertical axis 210.

The servo marks 202, 204, 206, 208 are also positioned to be centered on a centerline 212. A first servo mark on a servo write head is precisely positioned from a second servo mark on the servo write head. In FIG. 2, the first set of servo marks 202, 204 written by the servo write head are 50 microns apart at the centerline 212. Ideally, servo write heads repeat “A” pattern servo marks a precise distance apart so that the first servo mark of a first “A” pattern servo mark 202 is double the distance from the second servo mark of the first “A” pattern 204, as measured along the centerline 212. In FIG. 2, the first servo mark of the first “A” pattern 202 is ideally positioned at 100 microns from the first servo mark of the second “A” pattern 206, measured along the centerline 212.

Servo marks are typically sized and angled so that the sensing portion of a servo read head is much narrower than the servo marks on a servo track 104 as measured along the vertical axis 210. For example, a servo read head may be a few microns wide while a servo mark may be 186 microns high as measured along a vertical axis 210. A write head may lay down a data track 106 that is 10 microns wide. Servo marks are configured to allow a servo read head to position a read or write head over a 10 micron wide data track 106 as measured along the vertical axis 210.

For example, if a tape drive has two servo read heads with sixteen write heads in between, the servo read heads could sense servo marks on a servo track 104 and position the servo read heads near the top of an “A” pattern servo mark. Simultaneously, write heads connected to the servo read heads are positioned so a first write head is positioned just under a top servo mark. Each of the 16 write heads could then lay down a 10 micron wide data track 106 while the tape drive travels in a forward direction. The tape drive could then move the servo read heads and write heads down to a next data track position, maybe 11 microns down, and the write heads could lay down another 10 micron wide data track 106 while the tape 102 travels in a reverse direction. The tape drive repeats the process of moving the servo read heads and write heads down until a first write head lays down a last data track 106 just above a first data track 106 previously laid down by a second write head.

Once the space between servo tracks 104 is filled, the tape drive may move the servo read heads and write heads to another empty space between servo tracks 104. For example, if a tape 102 includes five servo tracks 104, four spaces between servo tracks 104 could be filled with data tracks 106. The height of the servo marks determines how many data tracks 106 may be written by each write head. For example, if an “A” pattern servo mark is 186 microns high and a write head writes 10 micron data tracks 106, sixteen data tracks 106 may be written by a single write head considering a small amount of space between data tracks 106 and allowing some space at the top and bottom of each “A” pattern servo mark that a servo read head should not pass beyond.

Servo read heads typically read servo marks using comparators, counters, etc. to sense when a servo mark passes under a servo read head. Tape drives use the slope of the servo marks to determine position on a servo mark. For example, if a servo read head is positioned above a centerline 212, a distance between the first servo mark of a first “A” pattern 202 and the second servo mark of the first “A” pattern 204 will be shorter than the distance measured at the centerline 212. The tape drive can determine from the timing of the servo marks where the servo read head is located in relation to the servo marks. However, if single “A” pattern servo marks are used, a tape drive would not be able to determine if a shortened signal derived from a servo read head positioned off the centerline 212 was above or below the centerline 212.

FIG. 3 is a depiction of a five burst “A” pattern servo mark 302, a four burst “A” pattern servo mark 304, and a servo write head for an “A” pattern servo mark 306. By using a five burst servo mark 302 followed by a four burst servo mark 304, a tape drive can distinguish between the two marks 302, 304 and an inverted “A” pattern formed between the servo marks 302, 304 and can then determine if a servo read head is above or below the centerline 212. For example, if a servo read head detects five servo marks followed by another five servo marks, the tape drive can determine that the servo read head read the first half of an “M” pattern servo mark.

The servo write head 306 creates a burst pattern 302, 304 by creating a first servo mark 202 and a second servo mark 204 simultaneously and then a second set of servo marks 206, 208 after the tape 102 has moved a short distance. The servo write head 306 repeats the servo marks 202, 204 until a four or a five burst “A” pattern servo mark 302, 304 is created. Once the servo write head 306 has created a five burst servo mark 302, the servo write head 306 allows tape 102 to pass and then repeats the process to create a four burst servo mark 304.

The servo write head 306 may also create longitudinal position (“LPOS”) data within a servo mark. For example, within a burst pattern of five servo marks 202, 204 in five burst servo mark 302, a servo write head 306 may shift the position of the second and the fourth servo marks 202, 204 with respect to the first, the third, and the fifth servo marks 202, 204. A shift in one direction may represent a one and a shift in the other direction may represent a zero. The ones and zeros of the LPOS information may then be used to encode information such as tape position within the servo marks formed on a tape 102. For example, LPOS information may form a counter on a tape 102 that may be used to located data at a specific location on the tape 102.

As indicated in relation to FIG. 2, ideally a first five burst servo mark 302 and a second four burst servo mark 304 are spaced equally so that the distance between the first written, first and second servo marks 202, 204 is the same as the first written, second servo mark of the first pattern 204 and the first written, first servo mark of the second pattern 206. In FIG. 3, this relationship is depicted by the distance between the first written first and second servo marks 202, 204 being 50 microns apart, as measured along the centerline 212, and the distance between the first written, first servo mark 202 of the five burst servo mark 302 and the first written, first servo mark 206 of the four burst servo mark 304 being approximately 100 microns.

However, an even spatial relationship between “A” pattern servo marks is ideal. Tape 102 variations and abnormalities often combine with minor variations in tape 102 speed to cause the spatial relationship to vary. The 100 micron distance between the first servo mark 202 of a five burst servo mark 302 and the first servo mark 206 of a four burst servo mark 304 varies enough to cause significant timing problems which may cause inaccuracies in measuring servo read head location, in determining LPOS data, and the like.

### SUMMARY OF THE INVENTION

From the foregoing discussion, it should be apparent that a need exists for an apparatus, system, and method that overcomes the deficiencies caused by “A” pattern servo marks. Beneficially, such an apparatus, system, and method would create an “M” pattern servo mark that would eliminate timing variations when sensing two “A” pattern servo marks.

The present invention has been developed in response to the present state of the art, and in particular, in response to the problems and needs in the art that have not yet been fully solved by currently available servo patterns. Accordingly, the present invention has been developed to provide an apparatus, system, and method for an “M” servo pattern that overcome many or all of the above-discussed shortcomings in the art.

The apparatus for an “M” servo pattern is provided with a plurality of modules configured to functionally execute the necessary steps of creating an “M” pattern servo marks on a servo track of a magnetic tape. These modules in the described embodiments include a servo pattern write module that simultaneously creates a first servo mark, a second servo mark, a third servo mark, and a fourth servo mark in an “M” servo pattern on a magnetic tape, the magnetic tape configured to store data. The first, second, third, and fourth servo marks are substantially linear and are substantially the same length. The first and third servo marks are positioned with a forward slope comprising first and third legs of the “M” pattern. The second and fourth servo marks are positioned with a backward slope comprising second and fourth legs of the “M” pattern. Distances between center points of the first and second servo marks, second and third servo marks, and third and fourth servo marks are substantially the same.

The servo pattern write module, in one embodiment, includes a first servo write head configured to write the first and second servo marks and a second servo write head configured to write the third and fourth servo marks. In another embodiment, the servo pattern write module includes a servo write head configured to write the first, second, third, and fourth servo marks. In another embodiment, the servo pattern write module creates more than four servo marks simultaneously. In yet another embodiment, an absolute value of the slope of the first and third servo marks is substantially the same and the absolute value of the slope of the second and fourth servo marks is substantially the same.

In one embodiment, the servo pattern write module includes a burst module that creates multiple first, second, third, and fourth servo marks in a regular pattern where a group of first servo marks is positioned before a group of second servo marks, the group of second servo marks is positioned before a group of third servo marks, and the group of third servo marks is positioned before a group of fourth servo marks. In one embodiment, the the burst module creates an equal number of first and second servo marks and an equal number of third and fourth servo marks and the number of first and second servo marks differs from the number of third and fourth servo marks. In another embodiment, the burst module creates LPOS data within at least one set of servo marks. In yet another embodiment, the burst module creates the LPOS data by shifting at least one servo mark relative to another servo mark. In an alternate embodiment, the burst module creates five first servo marks, five second servo marks, four third servo marks, and four fourth servo marks.

The apparatus to read an “M” servo pattern on magnetic tape is provided with a plurality of modules configured to functionally execute the necessary steps of reading “M” pattern servo marks on a servo track of a magnetic tape. These modules in the described embodiments include a servo read module that reads an “M” pattern servo mark on a servo track of a magnetic tape configured to store data. The “M” pattern servo mark is created by a servo pattern write module configured to simultaneously create a first servo mark, a second servo mark, a third servo mark, and a fourth servo mark.

The first, second, third, and fourth servo marks are substantially linear and are substantially the same length. The first and third servo marks are positioned with a forward slope comprising first and third legs of the “M” pattern. The second and fourth servo marks are positioned with a backward slope comprising second and fourth legs of the “M” pattern. Distances between center points of the first and second servo marks, second and third servo marks, and third and fourth servo marks are substantially the same. The apparatus includes a servo position module that repositions a data head assembly in response to position information received by the servo read module. The data head assembly includes at least one read head configured to read data from the magnetic tape or at least one write head configured to write data to the magnetic tape. In one embodiment, the servo read module reads an “M” pattern servo mark comprising a burst of first servo marks, a burst of second servo marks, a burst of third servo marks, and a burst of fourth servo marks.

A system of the present invention is also presented to create an “M” servo pattern. The system may be embodied by a tape formatting device. In particular, the tape formatting device, in one embodiment, includes a tape drive module that moves a magnetic tape from a first reel to a second reel and a servo pattern write module that simultaneously creates a first servo mark, a second servo mark, a third servo mark, and a fourth servo mark in an “M” servo pattern on the magnetic tape, the magnetic tape configured to store data. The first, second, third, and fourth servo marks are substantially linear and are substantially the same length. The first and third servo marks are positioned with a forward slope comprising first and third legs of the “M” pattern. The second and fourth servo marks are positioned with a backward slope comprising second and fourth legs of the “M” pattern. Distances between center points of the first and second servo marks, second and third servo marks, and third and fourth servo marks are substantially the same.

In one embodiment, the servo pattern write module includes a first servo write head configured to write the first and second servo marks and a second servo write head configured to write the third and fourth servo marks. In another embodiment, the servo pattern write module includes a servo write head configured to write the first, second, third, and fourth servo marks. In another embodiment, the tape formatting device includes a servo pattern write module for each servo track on a magnetic tape.

The system may further include a tape reader/writer configured with at least one servo read head that reads the “M” pattern servo marks of the magnetic tape formatted by the tape formatting device with “M” pattern servo marks. The at least one servo read head of the tape reader/writer reads an “M” pattern formed by first, second, third, and fourth servo marks without reading an “M” pattern formed by a third and a fourth servo mark of a first “M” pattern and a first and a second servo mark formed by a second “M” pattern.

A method of the present invention is also presented for creating an “M” servo pattern on a magnetic tape. The method in the disclosed embodiments substantially includes the steps necessary to carry out the functions presented above with respect to the operation of the described apparatus and system. In one embodiment, the method includes simultaneously creating at least one servo track comprising a plurality of “M” pattern servo marks on a magnetic tape configured to store data, the “M” pattern servo mark comprising a first servo mark, a second servo mark, a third servo mark, and a fourth servo mark in an “M” servo pattern. The first, second, third, and fourth servo marks are substantially linear and are substantially the same length. The first and third servo marks are positioned with a forward slope comprising first and third legs of the “M” pattern. The second and fourth servo marks are positioned with a backward slope comprising second and fourth legs of the “M” pattern. Distances between center points of the first and second servo marks, second and third servo marks, and third and fourth servo marks are substantially the same.

In a further embodiment, the method includes reading an “M” pattern servo mark on each servo track using a servo read head for each servo track configured to read an “M” pattern servo mark and repositioning at least one read head in response to position data received by a servo read head. In another embodiment, the method includes reading an “M” pattern servo mark on each servo track using a servo read head for each servo track configured to read an “M” pattern servo mark and repositioning at least one write head in response to position data received by a servo read head. In yet another embodiment, the method includes reading LPOS information contained within an “M” pattern servo mark.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustration of a representative segment of magnetic tape with servo tracks, data tracks, and a direction of travel of the magnetic tape from the prior art;

FIG. 2 is a block diagram illustration of typical “A” pattern servo marks on a servo track from the prior art;

FIG. 3 is a block diagram illustration of a five burst “A” pattern servo mark, a four burst “A” pattern servo mark, and a servo write head for an “A” pattern servo mark from the prior art;

FIG. 4 is a block diagram illustration of an “M” pattern servo mark and a servo pattern write module with two servo write heads in accordance with the present invention;

FIG. 5 is a block diagram illustration of an “M” pattern servo mark and a servo pattern write module with one servo write head in accordance with the present invention;

FIG. 6 is a block diagram illustration of a system for an “M” servo pattern in accordance with the present invention; and

FIG. 7 is a schematic flow chart diagram illustrating one embodiment of a method for an “M” servo pattern in accordance with the present invention.

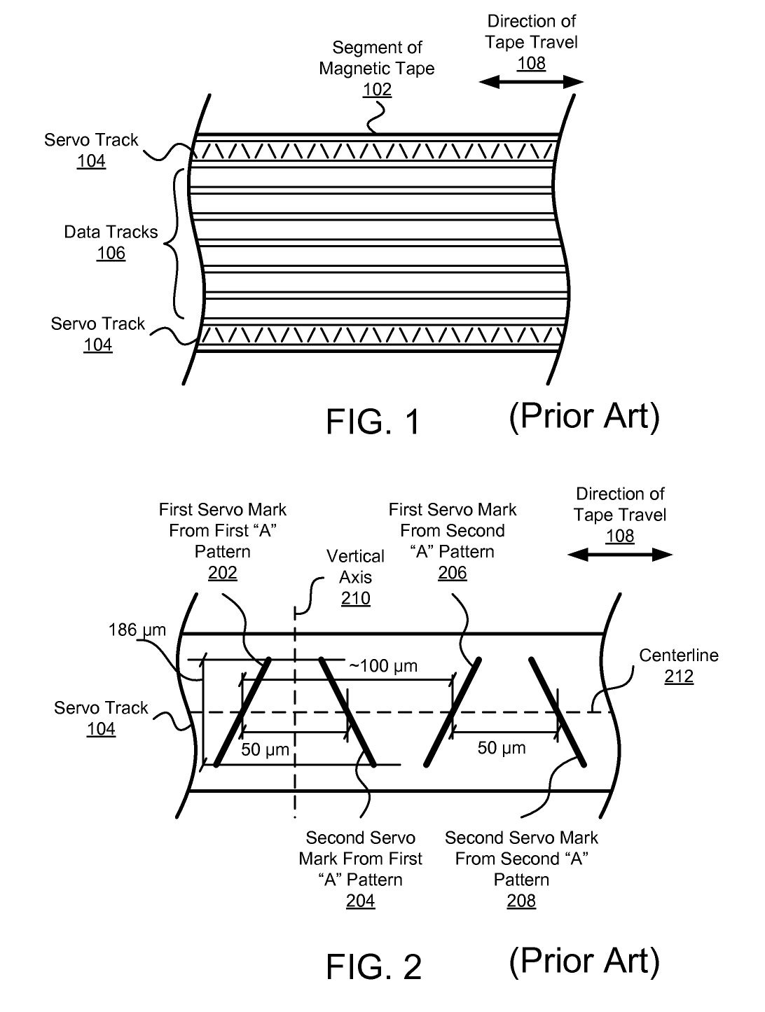

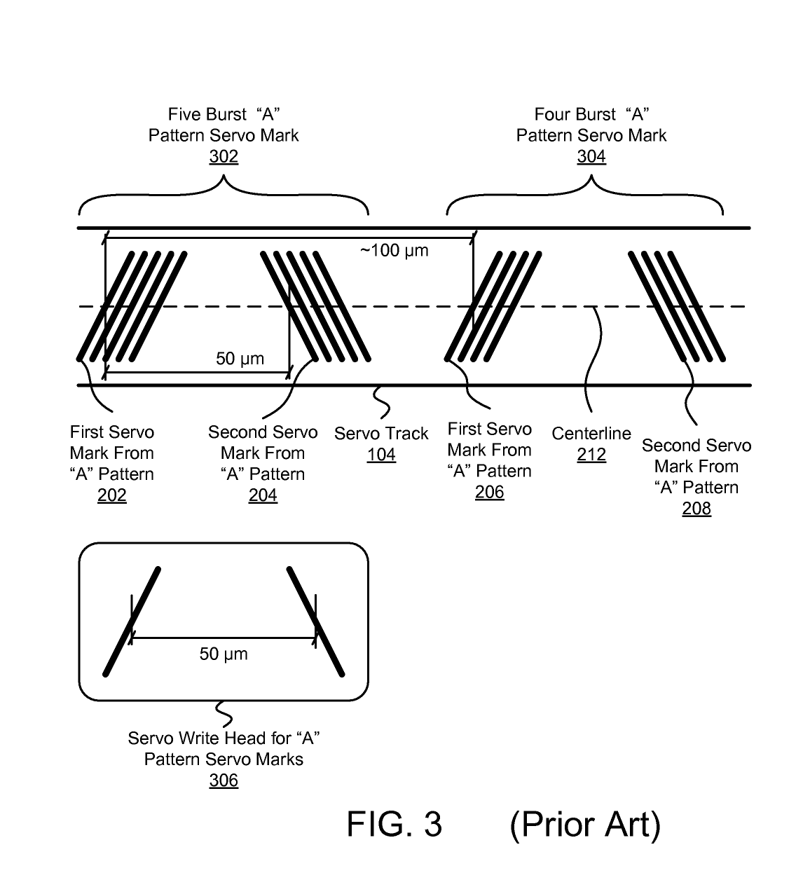

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

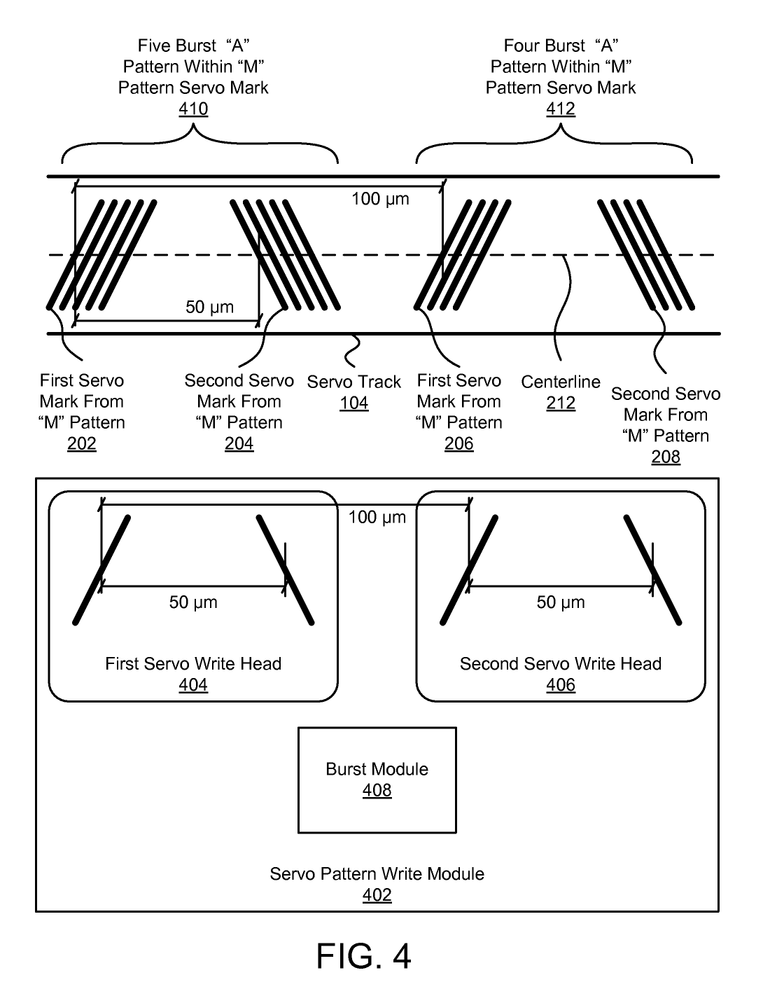

FIG. 4 is a block diagram illustration of an “M” pattern servo mark and a servo pattern write module 402 with two servo write heads, 404, 406 in accordance with the present invention. The servo pattern write module 402 includes a first servo write head 404 and a second servo write head 406 precisely positioned with respect to each other so that four servo marks 202, 204, 206, 208 can be formed simultaneously on a servo track 104. The first and second servo write heads 404, 406 are each capable of forming an “A” pattern servo mark. In other embodiments, the servo pattern write module 402 includes more than two servo write heads. For example, the servo pattern write module 402 may include three servo write heads and may form three “A” pattern servo marks.

By using two “A” pattern servo write heads 404, 406, the servo pattern write module 402 maintains a fixed distance between the two “A” pattern servo marks that form an “M” pattern servo mark. FIG. 4 indicates that the distance along a center line 212 between servo marks 202, 204 within a servo write head 404, 406 is 50 microns and the distance along a centerline 212 between the first servo marks 202, 206 of the servo write heads 404, 406 is 100 microns. The 100 micron distance is fixed and does not vary with tape speed, tape anomalies, etc. as it does when a single “A” pattern servo write head does while making consecutive “A” pattern servo marks.

In one embodiment, absolute value of the slope the first servo marks of an “A” pattern within an “M” pattern servo mark 202, 206 is the same as the slope of the second servo marks of an “A” pattern within an “M” pattern servo mark 204, 208. In another embodiment, the absolute value of the slope the first servo marks of an “A” pattern within an “M” pattern servo mark 202, 206 is different than the slope of the second servo marks of an “A” pattern within an “M” pattern servo mark 204, 208. For example, the first servo marks of an “A” pattern 202, 206 may be vertical or close to vertical while the second servo marks of an “A” pattern 204, 208 may be sloped. One of skill in the art will recognize other ways to form an “M” pattern servo mark with differing slopes using a servo pattern module 402 with a first servo write head 404 and a second servo write head 406.

A burst module 408 within the servo pattern write module 402 commands the first servo write head 404 to create one “A” pattern 410 with a certain number of servo pattern and the second servo write head 406 to create four burst “A” patterns 412 within the “M” pattern servo mark. For example, the burst module 408 directs both servo write heads 404, 406 to write four servo marks and then directs the first servo write head 404 to create a fifth set of servo marks 202, 204. As a result, the “M” pattern servo mark includes a five burst “A” pattern servo mark 410 and a four burst “A” pattern servo mark 412 precisely placed in relation to each other. This servo mark may be called a 5,5,4,4 “M” pattern servo mark. Creating a 5,5,4,4 “M” pattern servo mark is an advantage of a servo pattern write module 402 with two servo write heads 404, 406 because the two servo head 404, 406 servo pattern write module 402 is backward compatible with tape drives that read 5,5,4,4, servo marks formed using a single “A” pattern servo write head.

In another embodiment, the burst module 408 creates a 4,4,5,5 “M” pattern servo mark. In yet another embodiment, the burst module 408 creates a 4,4,3,3 “M” pattern servo mark. In one embodiment, the burst module 408 creates an “M” pattern servo mark that includes first and second servo marks 202, 204 of the same number and third and fourth servo marks 206, 208 of the same number and the number of first and second servo marks 202, 204 differs from the number of third and fourth servo marks 206, 208. Such an embodiment enables sensing phase information so that a tape drive can determine whether a servo reader is above or below a centerline 212. One of skill in the art will recognize other combinations of servo marks to enable a tape drive to determine a location of a servo reader with respect to a centerline 212.

In addition to creating bursts of servo marks, the burst module 408 may create longitudinal position (“LPOS”) data within a group of servo marks. The burst module 408 creates LPOS data by shifting servo marks within a group of servo marks forward and back with respect to the other servo marks within the group. Typically, a burst module 408 creates LPOS data within a five burst servo pattern by shifting the second and fourth servo marks with respect to the first, third, and fifth servo marks. However, the burst module 408 may shift other servo marks within a group and may shift servo marks in servo pattern groups with more or less than five servo marks.

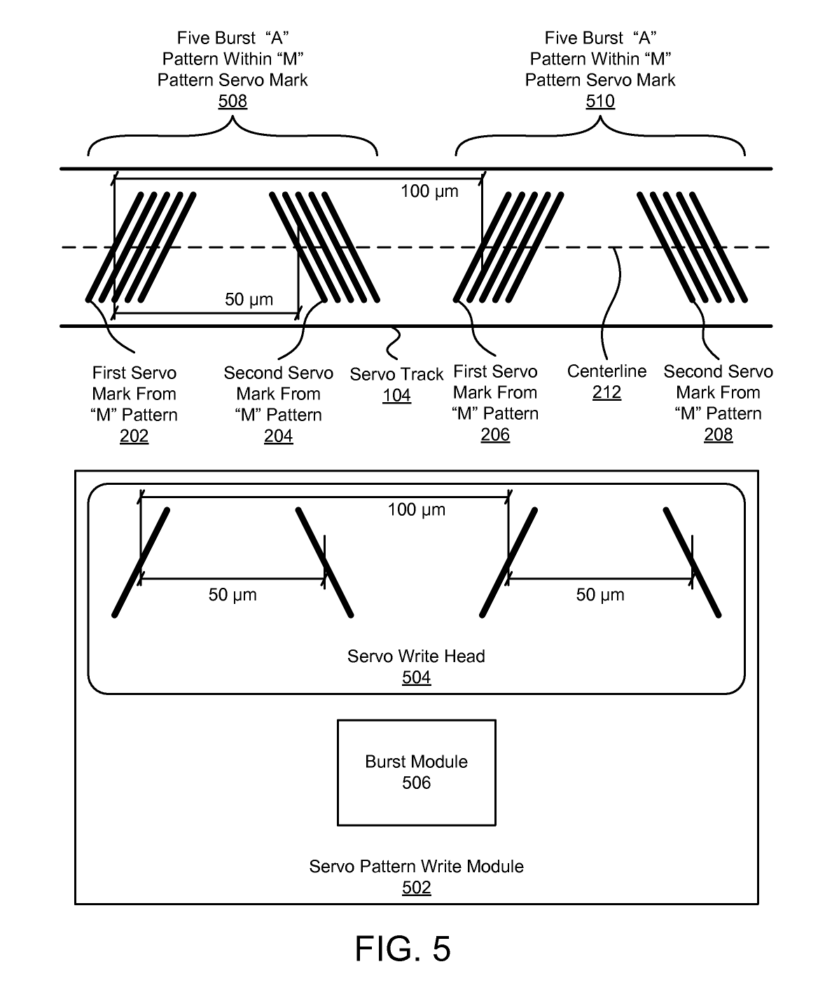

FIG. 5 is a block diagram illustration of an “M” pattern servo mark and a servo pattern write module 502 with one servo write head 504 in accordance with the present invention. The servo pattern write module 502 includes a servo write head 504 with servo marks precisely positioned with respect to each other so that four servo marks 202, 204, 206, 208 can be formed simultaneously on a servo track 104. The servo write head 504 is capable of forming an entire “M” pattern servo mark. In other embodiments, the servo pattern write module 502 includes a servo write head capable of making more than four servo marks. For example, the servo pattern write module 502 may include a servo write head and may form six servo marks in the form of three “A” pattern servo marks.

By using a single servo write head 504 the servo pattern write module 502 maintains a fixed distance between the servo marks created by the servo write head 504. FIG. 5 indicates that the distance along a center line 212 between servo marks 202, 204 within an “A” servo pattern forming the first part of an “M” pattern servo mark is 50 microns and the distance along a centerline 212 between the first servo marks 202, 206 of the first and second “A” patterns of the “M” pattern servo mark is 100 microns. The 100 micron distance is fixed and does not vary with tape speed, tape anomalies, etc. as it does when a single “A” pattern servo write head does while making consecutive “A” pattern servo marks.

A burst module 506 within the servo pattern write module 502 commands the servo write head 504 to create a five burst “M” pattern servo mark that includes two five burst “A” patterns 508, 510. For example, the burst module 506 directs the single servo write head 504 to write five servo marks. Subsequently the burst module 506 may direct the single servo write head 504 to write a four burst “M” pattern mark. This servo mark pattern may be called a 5,5,5,5,4,4,4,4 “M” pattern servo mark which would not be backward compatible with tape drives that read 5,5,4,4, servo marks formed using a single “A” pattern servo write head. The burst module 506 may create servo marks with a different number of marks, such as a 3,3,3,3,2,2,2,2 servo mark. One of skill in the art will recognize other “M” pattern servo marks that may be created using a burst module 502. The burst module 506 may also create LPOS data within a group of servo marks. Typically, with a single servo write head 504 that creates four servo marks 202, 204, 206, 208 simultaneously, LPOS data is created in each “M” pattern servo mark.

A servo pattern write module 502 with one servo write head 504 may be advantageous because of a reduced cost to make a single servo write head 504. In addition, a servo pattern write module 402 with two servo write heads 404, 406 may be more expensive to precisely position and install than a servo pattern write module 502 with a single servo write head 504. In addition, LPOS data is typically required in each burst of servo marks creating an “M” pattern servo mark, because including LPOS data in every other “M” pattern servo mark would reduce the amount of LPOS data written to a servo track 104.

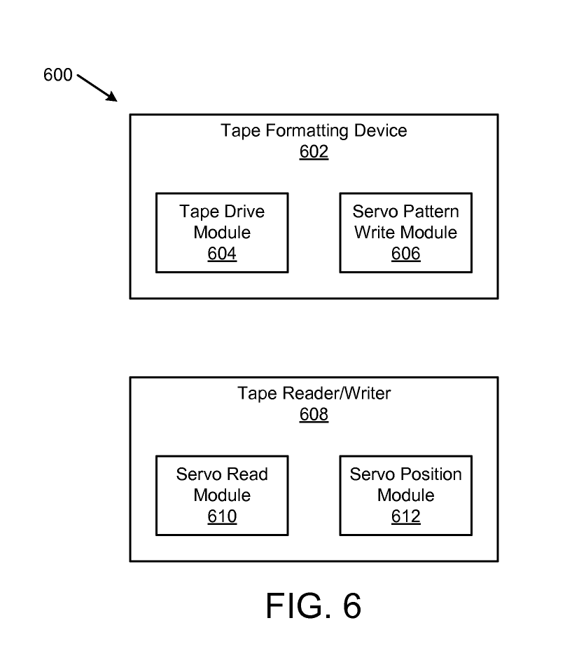

FIG. 6 is a block diagram illustration of a system 600 for an “M” servo pattern in accordance with the present invention. The system 600 includes a tape formatting device 602 with a tape drive module 604 and a servo pattern write module 606 and a tape reader/writer 608 with a servo read module 610 and a servo position module 612. The devices and modules are described below.

The system 600 includes a tape formatting device 602 for formatting magnetic tapes with servo tracks 104 that include “M” pattern servo marks. The tape formatting device 602 includes a tape drive module 604 that moves a tape 102 from a first reel to a second reel. The tape formatting device 602 also includes a servo pattern write module 606 that simultaneously creates a first servo mark 202, a second servo mark 204, a third servo mark 206, and a fourth servo mark 208 in an “M” servo pattern on a magnetic tape 102 where the first, second, third, and fourth servo marks 202, 204, 206, 208 are substantially linear and are substantially the same length.

The first and third servo marks 202, 206 are positioned with a forward slope comprising first and third legs of the “M” pattern servo mark and the second and fourth servo marks 204, 208 are positioned with a backward slope comprising second and fourth legs of the “M” pattern servo mark. Also, a distance between center points of the first and second servo marks 202, 204, second and third servo marks 204, 206, and third and fourth servo marks 206, 208 are substantially the same.

The servo pattern write module 606 may include a single “M” pattern servo write head 504 or two “A” pattern servo write heads 404, 406 positioned to simultaneously form an “M” pattern servo mark. The tape drive module 604 is configured to move a magnetic tape 102 across servo write head(s) 404, 406, 504 of the servo pattern write module 606 so that the servo pattern write module 606 may precisely write “M” pattern servo marks on the magnetic tape 102. The tape drive module 604 and servo pattern write module 606 include hardware, electronics, processors, software, etc. to create “M” pattern servo marks within servo tracks 104 of a magnetic tape 102.

The tape formatting device 602 may include more than one servo pattern write module 606 and may include a servo pattern write module 606 for each servo track 104 on a magnetic tape 102. Typically, a tape formatting device 602 includes a servo pattern write module 606 for each servo track 104 on an assembly that fixes a distance between servo write heads 404, 406, 504 along a vertical axis 210 of a magnetic tape 102. In one embodiment, the assembly fixes the servo write heads 404, 406, 504 for each servo track 104 along a same vertical axis 210. In such an embodiment, servo marks created by the servo write heads 404, 406, 504 may be created simultaneously or servo marks on each servo track 104 may be delayed from each other electronically. Delaying servo marks from one servo track 104 to another servo 104 has some advantages in detecting and handling errors on a magnetic tape 102.

In another embodiment, the tape formatting device 602 includes an assembly that has servo write heads 404, 406, 504 for each servo track 104 that are shifted from each other in the direction of tape travel 108. In such an embodiment, servo marks are delayed a fixed amount from servo track 104 to servo track 104. One of skill in the art will recognize other configurations of a tape formatting device 602 that includes one or more servo pattern write modules 606 with servo write head(s) 404, 406, 504 capable of creating “M” pattern servo marks on servo tracks 104 of a magnetic tape 102.

The system 600 includes a tape reader/writer 608 with a servo read module 610 that includes at least one servo read head that reads the “M” pattern servo marks of the magnetic tape 102 formatted by the tape formatting device 602 with “M” pattern servo marks. Typically, a tape reader/writer 608 includes at least two servo read heads for two servo tracks 104. The tape reader/writer 608 typically also includes either read heads for reading data tracks 106 or write heads to write data tracks 106 between the servo read heads. In one embodiment, the tape reader/writer 608 includes both read heads and write heads on an assembly between servo read heads. In another embodiment, the tape reader/writer 608 includes more than two servo read heads with read or write heads between two servo read heads.

In one embodiment, the tape reader/writer 608 includes sixteen read heads between two servo read heads. In another embodiment, the tape reader/writer 608 includes sixteen write heads between servo read heads. One of skill in the art will recognize other forms of a tape reader/writer 608 with servo read heads that read “M” pattern servo marks on a servo track 104 of a magnetic tape 102.

The servo read module 610 uses servo read heads to read each “M” pattern servo mark on a servo track 104. The servo read module 610 typically is capable of reading each “M” pattern servo mark without reading a second “A” pattern within a first “M” pattern servo mark together with a first “A” pattern of a second “M” pattern servo mark. Where “M” patterns are 5,5,4,4 “M” pattern servo marks, the servo read module 610 may simply recognize a single “M” pattern by detecting that a five burst servo mark 302 is a first “A” pattern of an “M” pattern. Where “M” patterns are 5,5,5,5,4,4,4,4 “M” pattern servo marks, the servo read module 610 may recognize an individual “M” pattern as two five burst “A” patterns or two four burst “A” patterns. One of skill in the art will recognize other ways that the servo read module 610 may distinguish between “M” pattern servo marks.

The tape reader/writer 608 includes a servo position module 612 that repositions servo read heads and a data head assembly in response to position information received by the servo read module 610. The data head assembly may include one or more read heads that read data from a magnetic tape 102 or one or more write heads that write data to the magnetic tape 102. The servo position module 612 typically includes a course positioning mechanism and a fine positioning mechanism. In one embodiment, the servo position module 612 electronically repositions servo read heads and read/write heads by changing a sensing position within each head. One of skill in the art will recognize other ways for a servo position module 612 to reposition servo read heads and a data head assembly in response to position information from a servo read module 610.

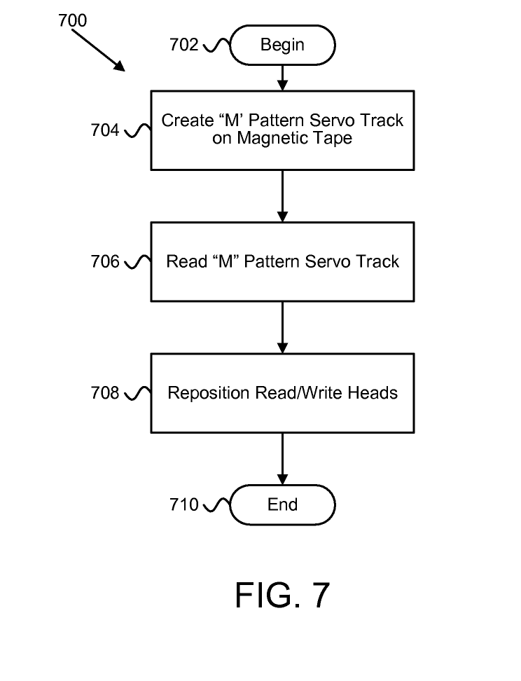

FIG. 7 is a schematic flow chart diagram illustrating one embodiment of a method 700 for an “M” servo pattern in accordance with the present invention. The method 700 begins 702 and the servo pattern write module 606 of a tape formatting device 602 creates 704 “M” pattern servo marks on a servo track 104 of a magnetic tape 102. Typically, one or more servo pattern write modules 606 create “M” pattern service marks on more than one servo tracks 104 of a magnetic tape 102. The servo read module 610 of a tape reader/writer 608 reads 706 “M” pattern servo tracks 104 of the magnetic tape 102. The servo position module 612 repositions 708 one or more read or write heads in response to the position information from the servo read module 610 and the method 700 ends 710.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to create an “m” servo pattern on a magnetic tape, the apparatus: comprising:
a servo pattern write module configured to simultaneously create a first servo mark, a second servo mark, a third servo mark, and a fourth servo mark in an “M” servo pattern on a magnetic tape, the magnetic tape configured to store data, wherein
the first, second, third, and fourth servo marks are substantially linear and are substantially the same length;
the first and third servo marks are positioned with a forward slope comprising first and third legs of the “M” pattern;
the second and fourth servo marks are positioned with a backward slope comprising second and fourth legs of the “M” pattern; and
distances between center points of the first and second servo marks, second and third servo marks, and third and fourth servo marks are substantially the same.

2. The apparatus of claim 1, wherein the servo pattern write module comprises a first servo write head configured to write the first and second servo marks and a second servo write head configured to write the third and fourth servo marks.

3. The apparatus of claim 1, wherein the servo pattern write module comprises a servo write head configured to write the first, second, third, and fourth servo marks.

4. The apparatus of claim 1, wherein the servo pattern write module creates more than four servo marks simultaneously.

5. The apparatus of claim 1, wherein an absolute value of the slope of the first and third servo marks is substantially the same and the absolute value of the slope of the second and fourth servo marks is substantially the same.

6. The apparatus of claim 1, wherein the servo pattern write module further comprises a burst module configured to create multiple first, second, third, and fourth servo marks in a regular pattern wherein a group of first servo marks is positioned before a group of second servo marks, the group of second servo marks is positioned before a group of third servo marks, and the group of third servo marks is positioned before a group of fourth servo marks.

7. The apparatus of claim 6, wherein the burst module creates an equal number of first and second servo marks and an equal number of third and fourth servo marks and the number of first and second servo marks differs from the number of third and fourth servo marks.

8. The apparatus of claim 6, wherein the burst module creates longitudinal position (“LPOS”) data within at least one set of servo marks.

9. The apparatus of claim 6, wherein the burst module creates the LPOS data by shifting at least one servo mark relative to another servo mark.

10. The apparatus of claim 6, wherein the burst module creates five first servo marks, five second servo marks, four third servo marks, and four fourth servo marks.

11. An apparatus to read an “M” servo pattern on a magnetic tape, the apparatus comprising:
a servo read module configured to read an “M” pattern servo mark on a servo track of a magnetic tape configured to store data, the “M” pattern servo mark created by a servo pattern write module configured to simultaneously create a first servo mark, a second servo mark, a third servo mark, and a fourth servo mark, wherein
the first, second, third, and fourth servo marks are substantially linear and are substantially the same length;
the first and third servo marks are positioned with a forward slope comprising first and third legs of the “M” pattern;
the second and fourth servo marks are positioned with a backward slope comprising second and fourth legs of the “M” pattern; and
distances between center points of the first and second servo marks, second and third servo marks, and third and fourth servo marks are substantially the same; and
a servo position module configured to reposition a data head assembly in response to position information received by the servo read module, the data head assembly comprising one of at least one read head configured to read data from the magnetic tape and at least one write head configured to write data to the magnetic tape.

12. The apparatus of claim 11, wherein the servo read module is further configured to read an “M” pattern servo mark comprising a burst of first servo marks, a burst of second servo marks, a burst of third servo marks, and a burst of fourth servo marks.

13. A system to create an “M” servo pattern on a magnetic tape, the system comprising:
a tape formatting device comprising a tape drive module configured to move a magnetic tape from a first reel to a second reel and a servo pattern write module configured to simultaneously create a first servo mark, a second servo mark, a third servo mark, and a fourth servo mark in an “M” servo pattern on the magnetic tape, the magnetic tape configured to store data, wherein
the first, second, third, and fourth servo marks are substantially linear and are substantially the same length;
the first and third servo marks are positioned with a forward slope comprising first and third legs of the “M” pattern;
the second and fourth servo marks are positioned with a backward slope comprising second and fourth legs of the “M” pattern; and
distances between center points of the first and second servo marks, second and third servo marks, and third and fourth servo marks are substantially the same.

14. The system of claim 13, wherein the servo pattern write module comprises a first servo write head configured to write the first and second servo marks and a second servo write head configured to write the third and fourth servo marks.

15. The system of claim 13, wherein the servo pattern write module comprises a servo write head configured to write the first, second, third, and fourth servo marks.

16. The system of claim 13, wherein the tape formatting device comprises a servo pattern write module for each servo track on a magnetic tape.

17. The system of claim 13, further comprising a tape reader/writer configured with at least one servo read head configured to read the “M” pattern servo marks of the magnetic tape formatted by the tape formatting device with “M” pattern servo marks, wherein the at least one servo read head of the tape reader/writer reads an “M” pattern formed by first, second, third, and fourth servo marks without reading an “M” pattern formed by a third and a fourth servo mark of a first “M” pattern and a first and a second servo mark formed by a second “M” pattern.

18. A computer program product comprising a computer readable medium having computer usable program code programmed for creating an “M” servo pattern on a magnetic tape, the operations of the computer program product comprising:
simultaneously creating at least one servo track comprising a plurality of “M” pattern servo marks on a magnetic tape configured to store data, the “M” pattern servo mark comprising a first servo mark, a second servo mark, a third servo mark, and a fourth servo mark in an “M” servo pattern, wherein
the first, second, third, and fourth servo marks are substantially linear and are substantially the same length;
the first and third servo marks are positioned with a forward slope comprising first and third legs of the “M” pattern;
the second and fourth servo marks are positioned with a backward slope comprising second and fourth legs of the “M” pattern; and
distances between center points of the first and second servo marks, second and third servo marks, and third and fourth servo marks are substantially the same.

19. The computer program product of claim 18, further comprising:
reading an “M” pattern servo mark on each servo track using a servo head for each servo track configured to read an “M” pattern servo mark; and
repositioning at least one read head in response to position data received by a servo read head.

20. The computer program product of claim 18, further comprising:
reading an “M” pattern servo mark on each servo track using a servo head for each servo track configured to read an “M” pattern servo mark; and
repositioning at least one write head in response to position data received by a servo read head.
